(19) United States
(12) Patent Application Publication
(10) Pub. No.: US 2006/0253408 A1
(43) Pub. Date: Nov. 9, 2006

(54) Method and system using profiles to control dissemination of data

(75) Inventor: Joseph L. Dvorak, Boca Raton, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/068,430

(22) Filed: Feb. 28, 2005

(51) Int. Cl. G06F 17/30

(52) U.S. Cl. 707/1

(57) ABSTRACT

A communication device (10) includes a transmitter (16) and a processor (12) coupled to the transmitter. The processor can be programmed to control dissemination of information of a user using a contextual profile (23 or 52, 54, or 56) for at least one recipient of the user, monitor a user's situational context (58), and transmit information (such as the user's current location) to the at least one recipient if the user's situational context matches the contextual profile for the recipient. The processor can monitor the user's situational context by monitoring at least one among the user's location, a current time, and a current date. Optionally, the processor can also monitor an application in use at the communication device. The communication device can further include a GPS receiver (27) and the processor monitors the user's situational context by monitoring a user's location using GPS data from the GPS receiver.

### FIELD OF THE INVENTION

This invention relates generally to controlling dissemination of information, and more particularly to a method and system for controlling dissemination using profiles.

### BACKGROUND OF THE INVENTION

There are more and more location aware applications and services available for use with cell phones and other mobile devices. However, many people are becoming uneasy at the prospect of their movements being continuously tracked, often without their knowledge or consent. Other than completely turning off a device, most existing devices fail give a user control of personal location data or information and how such information get disseminated.

In one existing system, location information is provided in order to deliver health information more relevant to a patient's current situation. There are many other services, for example, in retail, that use a person's location to deliver more personalized information. However, in each of these services, the user has no control or flexibility over the dissemination of the personal location information.

### SUMMARY OF THE INVENTION

Embodiments in accordance with the present invention utilizes profiles for particular recipients of a user to selectively control dissemination of information such as personal location information to such particular recipients.

In a first embodiment of the present invention, a method of controlling dissemination of information includes the steps of creating a contextual profile for at least one recipient of a user, monitoring a user's situational context, and transmitting information to the at least one recipient if the user's situational context matches the contextual profile for the at least one recipient. A contextual profile can contain at least one among a specified recipient or class of recipient, a specified time or time range, a specified date or date range, a specified application, and a location type. The contextual profile can further include a flag indicating whether the recipient would need to request from the user permission for transmitting the information to a particular recipient. Monitoring the user's situational context can include monitoring at least one among the user's location, a current time where the user is located, and a current date where the user is located. The step of transmitting information can include the step of transmitting a user's current location. Note, monitoring the user's situational context can include monitoring a user's location using at least one among GPS data, location beacon data, and triangulation data. Such monitoring can further include monitoring the application in use at by the user.

In a second embodiment of the present invention, a communication device can include a transmitter and a processor coupled to the transmitter. The processor can be programmed to control dissemination of information of a user using a contextual profile for at least one recipient of the user, monitor a user's situational context, and transmit information (such as the user's current location) to the at least one recipient if the user's situational context matches the contextual profile for the at least one recipient. The contextual profile can include at least one among a specified recipient or class of recipient, a specified time or time range, a specified date or date range, a predetermined application operating at the communication device, and a location type. The contextual profile can further include a flag indicating whether the recipient would need to request from the user permission for transmitting the information to a particular recipient. The processor can monitor the user's situational context by monitoring at least one among the user's location, a current time where the user is located, and a current date where the user is located. Optionally, the processor can also monitor the user's situational context by monitoring an application in use at the communication device. The communication device can further include a GPS receiver and the processor monitors the user's situational context by monitoring a user's location using GPS data from the GPS receiver.

In a third embodiment of the present invention, a communication device using a contextual profile to control dissemination of personal location data can include a transmitter, a receiver enabling a determination of current location data for the communication device, a memory for storing at least one contextual profile for a predetermined recipient type of the personal location data, and a processor coupled to the transmitter. The processor can be programmed to programmatically control dissemination of the current location data using the contextual profile for the predetermined recipient type, monitor a user's situational context including the current location data and at least one among a time, date, location type, enable transmission of the current location data to at least one recipient matching the predetermined recipient type if the user's situational context matches the contextual profile for the predetermined recipient type. The receiver can be at least one among a GPS receiver or a receiver used for obtaining location information using triangulation or a location beacon. The contextual profile can include at least one among a specified recipient or class of recipient, a specified time or time range, a specified date or date range, and a location type. The contextual profile can further include a flag indicating whether the at least one recipient would need to request from the user to transmit the personal location data to the at least one recipient. Note, the processor can optionally monitor the user's situational context by monitoring an application in use at the communication device.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of a communication device using a contextual profile to control dissemination of information in accordance with an embodiment of the present invention.

FIG. 2 is an illustration of using contextual profiles for recipients to enable transmission of a user's personal information to such recipients in accordance with an embodiment of the present invention.

FIG. 3 is a flow chart illustrating a method of controlling dissemination of information using contextual profiles in accordance with an embodiment of the present invention

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

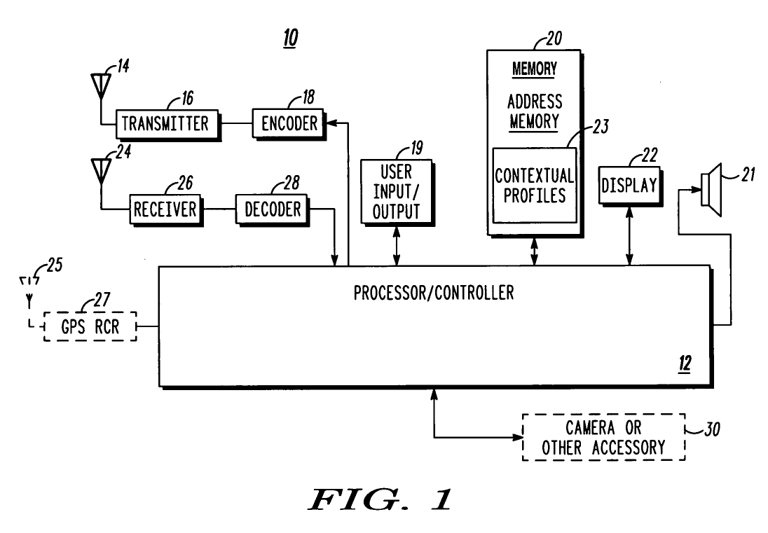

Referring to FIG. 1, a communication device 10 such a mobile telephone or camera phone can include a processor 12 programmed to function in accordance with the described embodiments of the present invention. The portable communication device 10 can include an encoder 18, transmitter 16 and antenna 14 for encoding and transmitting information as well as an antenna 24, receiver 26 and decoder 28 for receiving and decoding information sent to the portable communication device. The communication device 10 can further include a memory 20, a display 22 for at least displaying a graphical user interface, and a speaker 21 for providing an audio output. The memory 20 can further include one or more contextual profiles 23 for one or more corresponding recipients. The processor or controller 12 can be further coupled to a display 22, a speaker 21, the encoder 18, the decoder 28, and the memory 20. The memory 20 can include address memory, message memory, and memory for database information which can include the contextual profiles 23. Additionally, the communication device 10 can include a user input/output device(s) 19 coupled to the processor 12. The input device 19 can be a microphone for receiving voice instructions that can be transcribed to text using voice-to-text logic for example. Of course, input device 19 can also be a keyboard, a keypad, a handwriting recognition tablet, or some other Graphical User Interface for entering text or other data. Optionally, the communication device 10 can further include a GPS receiver 27 and antenna 25 coupled to the processor 12 to enable location determination of the communication device. Of course, location or estimated location information can be determined with just the receiver 26 using triangulation techniques or identifiers transmitted over the air. Further note, the communication device can include any number of applications and/or accessories 30 such as a camera. In this regard, personal information can not only include location information, but pictures or video that is currently available at the communication device.

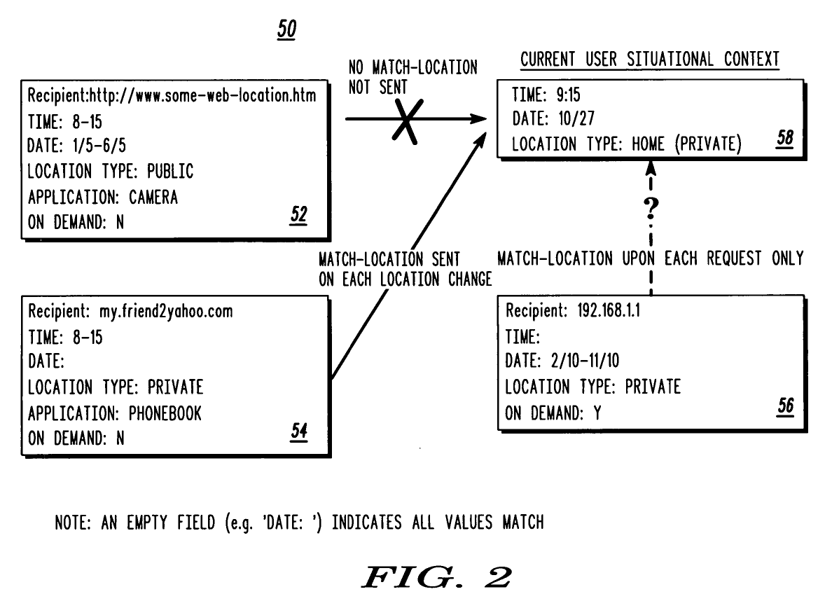

Referring to FIG. 2, an illustration 50 of a plurality of contextual profiles 52, 54, and 56, each used to control dissemination of information such as personal location data to a specified recipient. The processor 12 (of FIG. 1) can be programmed to programmatically control dissemination of the current location data or other personal information using the contextual profile for the predetermined recipient type and further monitor a user's situational context 58 including the Current location data and at least one among a time, date, location type. The user's situation context can also include information regarding the type or specific application being used at the communication device. For example, not only can a user control dissemination of personal location information, but there may be instances where certain data such as video or pictures either stored or currently captured at the communication device would not be transmitted to one or more predetermined recipients. The contextual profile can include at least one among a specified recipient or class of recipient, a specified time or time range, a specified date or date range, and a location type. The contextual profile can further include a flag indicating whether the at least one recipient would need to request from the user to transmit the personal location data (or other data) to the at least one recipient. Note, the processor can optionally monitor the user's situational context by monitoring an application in use at the communication device. Thus, the contextual profiles can disable transmission of the current location data or other sensitive data to at least one recipient matching the predetermined recipient type if the user's situational context matches the contextual profile for the predetermined recipient type.

In the specific example shown in FIG. 2, a ‘User Profile’ (URP) that determines whether or not the user's location will be transmitted to a specified receiver (person or machine) can be created and maintained. The profile (52, 54 or 56) can include fields, each defining an element of context and a value. When a user's current situational context 58 matches all of the context elements of a specific URP, the user's current location information (or other sensitive information) can be sent to the recipient specified in the URP. The context elements can include a specified recipient (using a URL, IP address, email address, or other recipient address), a specific time or time interval (e.g. 8-14), a specific date or date interval (e.g. 9/1 through 12/1), a Location Type (explained Below), an On Demand flag (explained below), and an optional application type.

The location type can specify what types of location could be sent to the specified recipient when all other context elements of this profile were matched. For example, locations can be divided into Private (user's home and all locations within the home) or Public (all non-Private locations). The On Demand flag can be true if the recipient specified in this profile must request each transmission of the user's location when all elements of the profile are matched. The On Demand flag can be set to false if at any time all context elements of the profile were matched, the user is able to send their location information to the specified recipient. In such an instance, the recipient does not need to ask for each transmission, rather, the transmission will be automatically sent if all context elements of the profile match the user's situational context. Also, if an application is running such as a camera or video, the profile can specify if such data can be transmitted to a specified recipient. The profile can specify that location information can be sent, but not image data or vice versa.

URPs allow the user to control the conditions under which their location information or other sensitive information is sent and the recipients of that information. URPs can be used with any type of location information (GPS, location beacons, etc) or with any type of data (video, audio, image, text, etc.). Thus, URPs can offset some of the uneasiness users may feel about using location aware services since they will maintain control over when, how, and to whom that information is sent or disseminated. URPs can be used on any mobile device capable of determining its location or capable of gathering user perceived sensitive information (personal images or audio), in whatever form, and transmitting it to a remote recipient. These mobile or communication devices or include cell phones, PDAs, and laptop PCs for example.

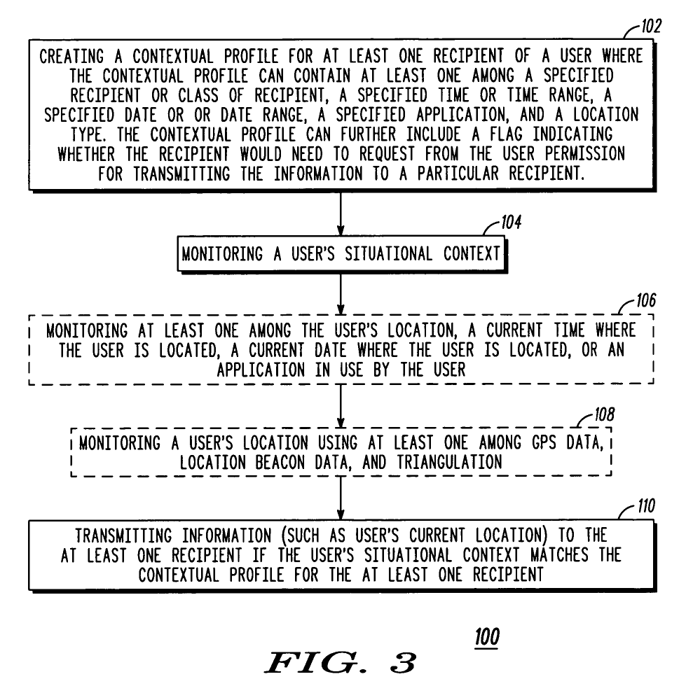

Referring to FIG. 3, a flow chart illustrating a method 100 of controlling dissemination of information can include the step 102 of creating a contextual profile for at least one recipient of a user where the contextual profile can contain at least one among a specified recipient or class of recipient, a specified time or time range, a specified date or date range, a specified application, and a location type. The contextual profile can further include a flag indicating whether the recipient would need to request from the user permission for transmitting the information to a particular recipient. The method 100 can further include step 104 of monitoring a user's situational context which can optionally include monitoring at least one among the user's location, a current time where the user is located, a current date where the user is located, or an application in use by the user at step 106. Optionally, monitoring a user's situational context can include monitoring a user's location using at least one among GPS data, location beacon data, or triangulation at step 108. The method 100 can also include the step 110 of transmitting information (such as a user's current location) to at least one recipient if the user's situational context matches the contextual profile for the at least one recipient.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of controlling dissemination of information, comprising the steps of:
creating a contextual profile for at least one recipient of a user;
monitoring a user's situational context; and
transmitting information to the at least one recipient if the user's situational context matches the contextual profile for the at least one recipient.

2. The method of claim 1, wherein the step of creating the contextual profile comprises the step of creating a profile containing at least one among a specified recipient or class of recipient, a specified time or time range, a specified date or date range, a specified application, and a location type.

3. The method of claim 1, wherein the step of creating the contextual profile further comprises creating a flag indicating whether the recipient would need to request from the user permission for transmitting the information to a particular recipient.

4. The method of claim 1, wherein the step of monitoring the user's situational context comprises monitoring at least one among the user's location, a current time where the user is located, and a current date where the user is located.

5. The method of claim 1, wherein the step of transmitting information comprises the step of transmitting a user's current location.

6. The method of claim 1, wherein the step of monitoring the user's situational context comprises monitoring a user's location using at least one among GPS data, location beacon data, and triangulation data.

7. The method of claim 1, wherein the step of monitoring the user's situational context comprises monitoring an application in use where the user is located.

8. A communication device, comprising:
a transmitter; and
a processor coupled to the transmitter, wherein the processor is programmed to:
control dissemination of information of a user using a contextual profile for at least one recipient of the user;
monitor a user's situational context; and
transmit information to the at least one recipient if the user's situational context matches the contextual profile for the at least one recipient.

9. The communication device of claim 8, wherein the contextual profile comprises at least one among a specified recipient or class of recipient, a specified time or time range, a specified date or date range, a predetermined application operating at the communication device, and a location type.

10. The communication device of claim 8, wherein the contextual profile further-comprises a flag indicating whether the recipient would need to request from the user permission for transmitting the information to a particular recipient.

11. The communication device of claim 8, wherein the processor monitor the user's situational context by monitoring at least one among the user's location, a current time where the user is located, and a current date where the user is located.

12. The communication device of claim 8, wherein the processor is programmed to transmit a user's current location.

13. The communication device of claim 8, wherein the communication device further comprises a GPS receiver and the processor monitors the user's situational context by monitoring a user's location using GPS data from the GPS receiver.

14. The communication device of claim 1, wherein the processor monitors the user's situational context by monitoring an application in use at the communication device.

15. A communication device using a contextual profile to control dissemination of personal location data, comprising:
a transmitter;
a receiver enabling a determination of current location data for the communication device;
memory for storing at least one contextual profile for a predetermined recipient type of the personal location data; and
a processor coupled to the transmitter, wherein the processor is programmed to:
programmatically control dissemination of the current location data using the contextual profile for the predetermined recipient type;
monitor a user's situational context including the current location data and at least one among a time, date, location type; and
enable transmission of the current location data to at least one recipient matching the predetermined recipient type if the user's situational context matches the contextual profile for the predetermined recipient type.

16. The communication device of claim 15, wherein the receiver is at least one among a GPS receiver or a receiver used for obtaining location information using triangulation or location beacon data.

17. The communication device of claim 15, wherein the contextual profile comprises at least one among a specified recipient or class of recipient, a specified time or time range, a specified date or date range, and a location type.

18. The communication device of claim 15, wherein the contextual profile further comprises a flag indicating whether the at least one recipient would need to request from the user to transmit the personal location data to the at least one recipient.

19. The communication device of claim 15, wherein the processor monitors the user's situational context by monitoring an application in use at the communication device.
